(19) United States
(12) Patent Application Publication
(10) Pub. No.: US 2005/0030293 A1
(43) Pub. Date: Feb. 10, 2005

(54) Method for predicting and estimating coordinates of a touch panel

(76) Inventor: Chih Chang Lai, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/633,526

(22) Filed: Aug. 5, 2003

(51) Int. Cl. G09G 5/00

(52) U.S. Cl. 345/173

(57) ABSTRACT

A method for predicting and estimating coordinates of a touch panel provides a filter to the touch panel. The filter predicts the antecedent and estimating X-coordinate and Y-coordinate by predict technique to calculate a sampling cycle, a predicted X-coordinate and a predicted Y-coordinate. And then the filter estimates the estimating X-coordinate and Y-coordinate by using the predicted X-coordinate, the predicted Y-coordinate, the present measurement X-coordinate and the present measurement Y-coordinate and relying on the Orthogonal Principle. Consequently, the estimating X-coordinate and the Y-coordinate are more accurate than that of the conventional touch panel and has a good relationship with adjacent coordinates.

### BACKGROUND OF THE INVENTION

1. Field of the Invention

The present invention relates to a method for estimating coordinates, and more particularly to a method for predicting and estimating coordinates of a touch panel.

2. Description of Related Art

A conventional touch panel usually comprises an indium tin oxide glass (ITO glass) and an indium tin oxide film (ITO film) that are combined to form a glass panel. By touching the glass panel and via a conductor, a printed circuit board (PCB) with an integrated circuit (IC), an image is shown on a screen. According to the sensing modes, the touch panels are approximately divided into three types, such as resistance mode, capacitance mode and the induction mode, wherein the resistance mode is most widely used and divided into 4-wired and 5-wired types. The ITO glass and the ITO film are wired according to the X-axis and the Y-axis thereof. As usual, the ITO film is mounted on a top face of the ITO glass and a thin spacer is sandwiched between the ITO film and the ITO glass. The ITO glass and the ITO film are conducted and form a potential difference to achieve the function of ON/OFF when the ITO film is pressed by user's finger, a digital pen of the like. Then, a signal is transmitted to a microprocessor for calculating where the ITO film is pressed.

All the conventional touch panels detect the X-coordinates and the Y-coordinates on the touch panel. However, the coordinates value detected by the conventional tough panel usually includes somewhat miscellaneous. Consequently, a difference is certainly contained.

The present invention has arisen to mitigate and/or obviate the disadvantages of the conventional method for estimating coordinates of a touch panel.

### SUMMARY OF THE INVENTION

The main objective of the present invention is to provide an improved method for predicting and estimating coordinates of a touch panel.

To achieve the objective, the method provides a filter to the touch panel. The filter predicts the antecedent and estimating X-coordinate and Y-coordinate by predict technique to calculate a sampling cycle, a predicted X-coordinate and a predicted Y-coordinate. And then the filter estimates the estimating X-coordinate and Y-coordinate by using the predicted X-coordinate, the predicted Y-coordinate, the present measurement X-coordinate and the present measurement Y-coordinate and relying on the Orthogonal Principle. Consequently, the estimating X-coordinate and the Y-coordinate are more accurate than that of the conventional touch panel and has a good relationship with adjacent coordinates.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method for estimating coordinates of a touch panel in accordance with the present invention; and

FIG. 2 is a graph for comparing the measurement position to the estimation position and the true position of the touch panel.

### DETAILED DESCRIPTION OF THE INVENTION

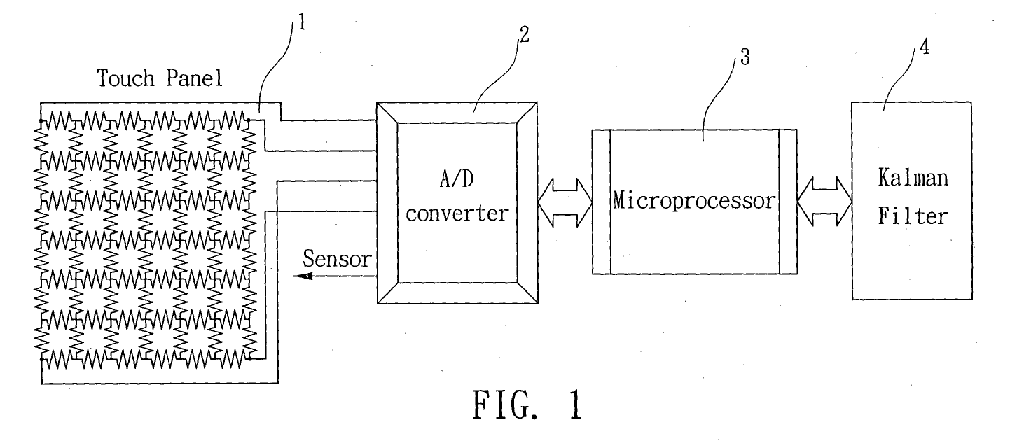

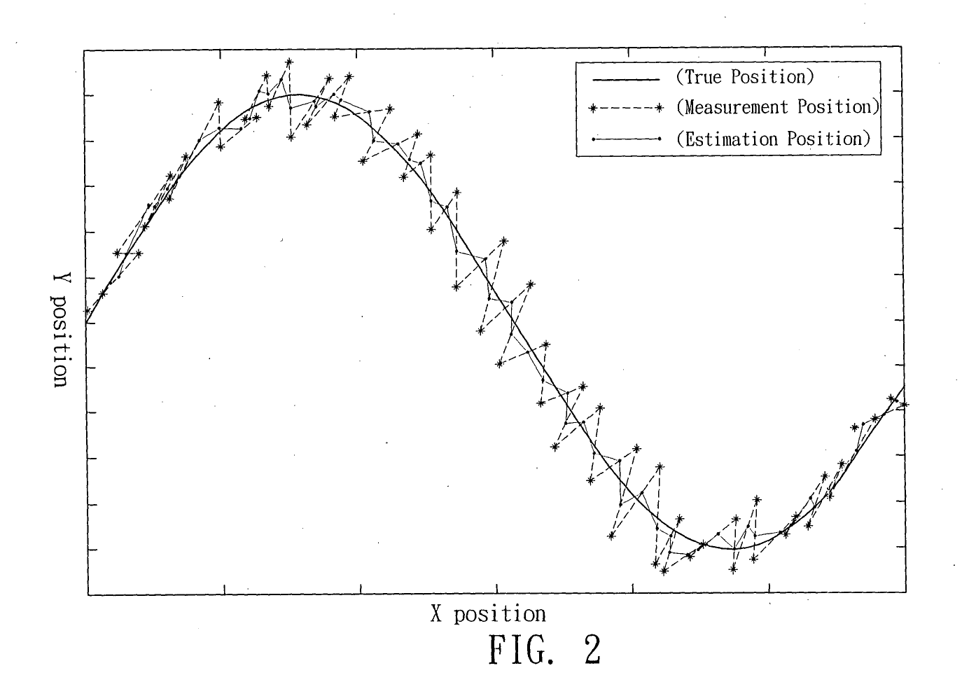

Referring to the drawings and initially to FIGS. 1 and 2, for being used in a method for estimating coordinates of a touch panel in accordance with the present invention, the touch panel (1) is 5-wired and comprises an A/D converter (2) electrically connected to the touch panel (1), a microprocessor (3) electrically connected to the A/D converter (2) and a Kalman filter (4) algorithm embedded the microprocessor (3). The touch point on the touch panel (1) has an X-coordinate and a Y-coordinate each transmitting an analogy voltage to the A/D converter (2) that transform the two analogy voltages into two 12 bits digital signals. The two 12 bits digital signals are transmitted to the microprocessor (3) for locating the X-coordinate and the Y-coordinate on the touch panel (1). The Kalman filter (4) predicts the antecedent and estimating X-coordinate and Y-coordinate by predict technique to calculate a sampling cycle, a predicted X-coordinate and a predicted Y-coordinate. And then the filter estimates the estimating X-coordinate and Y-coordinate by using the predicted X-coordinate, the predicted Y-coordinate, the present measurement X-coordinate and the present measurement Y-coordinate and relying on the Orthogonal Principle. Consequently, the estimating X-coordinate and the Y-coordinate are more accurate than that of the conventional touch panel and has a good relationship with adjacent coordinates.

The method includes the following formulas.

To suppose the X-coordinate and the Y-coordinate on the touch panel (1) is the Xdata and Ydata that have a linear formula as follow.

$$Z ( k ) = θ m ( k ) + vm ( k ) , θ m ( k ) = [ \begin{matrix}Xdata ( k ) \\ Ydata ( k )\end{matrix} ]$$

Z(k) is the measured Xdata(k) and Ydata(k), Vm(k) is the average value εₘ and the variation value δₘ is from the white Gauss miscellaneous signals.

A. The Predicting formula:
\hat{θ}m(k|k−1)=A*\hat{θ}m(k−1|k−1)
P(k|k−1)=A^{T}P(k−1|k−1)A+ωm(k−1)
wherein

$$A = [ \begin{matrix}1 & 0 \\ 0 & 1\end{matrix} ] , P ( 0 \vert 0 ) = [ \begin{matrix}1 & 0 \\ 0 & 1\end{matrix} ] and ω m ( 0 ) = [ \begin{matrix}qm & 0 \\ 0 & qm\end{matrix} ] ,$$

P(k) is the predicting factor and wm(k) is the predicting miscellaneous signal Variation value.

B. The estimating formula:
K(k)=P(k|k−1)C^{T}[CP(k|k−1)C^{T}+νm(k)]⁻¹
\hat{θ}m(k|k)=A\hat{θ}(k|k−1)+K(k)[Z(k)−C\hat{θ}m(k|k−1)]
P(k|k)=[I−K(k)C]P(k|k−1)
wherein

$$vm ( k ) = [ \begin{matrix}δ m & 0 \\ 0 & δ m\end{matrix} ] , C = 1 , I = [ \begin{matrix}1 & 0 \\ 0 & 1\end{matrix} ]$$

and K(k) is the estimating factor.

The Z and \hat{θ}(k|k−1) in the above formula are combined to estimate the final X-coordinate and the final Y-coordinate values \hat{Z}(k)=\hat{θ}m(k|k).

With reference to FIG. 2, a Matlab software is used to simulate a sine-wave on the touch panel. The formula for setting the X-coordinate and the Y-coordinate of the sine-wave is followed.
X-coordinate is set from 0 to 6.28 and the interval between two
X-coordinates is 0.1 such that the group of X-coordinates and
Y-coordinates has 62 pieces.
   X=0:0.1:2×3.14;
   Y=sin(x);

Setting parameters: Pk(1)=1, wm=0.1 and vm=0.1; Pk indicates the predict factor, wm indicates estimate error and vm indicates the miscellaneous signal from the variation value.

The signal includes miscellaneous signals when the microprocessor (3) explains the positions Xdata and Ydata of X-coordinate and Y-coordinate. The vx is miscellaneous signal of X-coordinate and the vy if the miscellaneous signal of Y-coordinate.

The group of the X-coordinate and the Y-coordinate includes 62 pieces.
for i=1:1:62

The miscellaneous signal of X-coordinate is supposed as ±0.2 and the miscellaneous signal of Y-coordinate is supposed as ±0.2.
vx(i)=(−1)\hat{ }i×rand(1)/5;
vy(i)=(−1)\hat{ }i×rand(1)/5;
Xdata(i)=x(i)+vx(i);
Ydata(i)=y(i)+vy(i);

The Kalman filter is used to predict the Xdata and the Ydata by predict technique to calculate a sampling cycle and get a predict value Xt and Yt. The Kalman filter read the new measure value and uses the Orthogonal Principle to renew the Xdata and the Ydata respectively into Xtt and Ytt. The SNR_m indicates the error quantity of the Xdata and the Ydata. The SNR_p indicates the error quantity of the Xtt and the Ytt. The formula is now as follow, wherein the Kk(i) is the estimate factor. The Original data of X-coordinate is equal to the measure data:
Xtt(1)=Xdata(1) and the original data of Y-coordinate is equal to the measure data: Ytt(1)=Ydata(1). The original error between the measure data and the true data is set as zero: SNR_m=0 and the error between the estimate data and the true data is set as zero: SNR_p=0. The Kalman filter starts predicting at the second piece of the X-coordinate and the Y-coordinate: for i=2:1:62. The Xt is predicted from the Xdata:
Xt(i)=Xdata(i−1) and the Yt is predicted from the Ydata: Yt(i)=Ydata(i−1). The predict factor is calculated from the previous predict factor and the wm: Pk(i)=Pk(i−1)+wm and the formula for calculating the estimating factor is Kk(i)=Pk(i)/(Pk(i)+vm). The formula for calculating the estimating X-coordinate: Xtt(i)=Xt(i)+Kk(i)×(Xdata(i)−Xt(i)) and the formula for calculating the estimating Y-coordinate is:
Ytt(i)=Yt(i)+Kk(i)×(Ydata(i)−Yt(i)). The formula for renewing the Pk(i) is: Pk(i)=(1−Kk(i))×Pk(i).

The formula for calculating the error between the measure data and the true data is: SNR1=(Xdata(i)−x(i))\hat{ }2+(Ydata(i)−y(i))\hat{ }2 and the formula for calculating the error between the estimate data and the true data is: SNR2=(Xtt(i)−x(i))\hat{ }2+(Ytt(i)−y(i))\hat{ }2. The formula for calculating the sum of all of the measure errors is: SNR_m=SNR_m+SNR1 and the formula for calculating the sum of all of the estimating errors is: SNR_p=SNR_p+SNR2.

With reference to FIG. 2, the Xtt and the Ytt are estimated by the Kalman filter (4) and closer to the sine-wave than the Xdata and the Ydata. As shown in FIG. 2, the SNR_p=0.3645<SNR_m=1.5687, the Xtt and the Ytt has a smaller error that that of the Xdata and the Ydata. Consequently, the final X-coordinate and the Y-coordinate is more accurate than that of the conventional touch panel and has a good relationship with an adjacent coordinates.

Although the invention has been explained in relation to its preferred embodiment, it is to be understood that many other possible modifications and variations can be made without departing from the spirit and scope of the invention as hereinafter claimed.

1. A method for predicting and estimating coordinates of a touch panel providing a filter to the touch panel, the filter predicting the antecedent and estimating X-coordinate and Y-coordinate by predict technique to calculate a sampling cycle, a predicted X-coordinate and a predicted Y-coordinate. And then the filter estimates the estimating X-coordinate and Y-coordinate by using the predicted X-coordinate, the predicted Y-coordinate, the present measurement X-coordinate and the present measurement Y-coordinate and relying on the Orthogonal Principle. Consequently, the estimating X-coordinate and the Y-coordinate are more accurate than that of the conventional touch panel and has a good relationship with adjacent coordinates.

2. The method as claimed in claim 1, wherein the filter is a Kalman filter.
